(19) United States
(12) Patent Application Publication
(10) Pub. No.: US 2026/0339552 A1
(43) Pub. Date: Oct. 29, 2026

(54) MEMORY CONTROL METHOD AND STORAGE DEVICE

(71) Applicant: Hefei Kaimeng Technology Co., Ltd., Anhui (CN)

(72) Inventors: Wenjun Chai, Anhui (CN); Jianhua Sun, Anhui (CN); Jiaxing Du, Anhui (CN); Qiao ZHU, Anhui (CN); Boyan Lu, Anhui (CN)

(73) Assignee: Hefei Kaimeng Technology Co., Ltd., Anhui (CN)

(21) Appl. No.: 19/681,026

(22) Filed: May 18, 2026

(30) Foreign Application Priority Data
May 21, 2025 (CN) 202510659400.1

(51) Int. Cl. G06F 3/06

(52) U.S. Cl. CPC G06F 3/0658; G06F 3/0619; G06F 3/0679

(57) ABSTRACT

Disclosed are a memory control method and a storage device. The method includes: reading first data from a first physical unit in the memory module; after obtaining the first data from the memory module, on the premise of not performing a decoding operation on the first data through a decoding circuit, performing a data quality analysis on the first data to obtain a quality analysis result; if the quality analysis result is a first result, directly initiating a re-read operation for the first physical unit to re-read the first physical unit through a re-read voltage to obtain second data.

### CROSS-REFERENCE TO RELATED APPLICATION

This application claims the priority benefit of China application serial no. 202510659400.1, filed on May 21, 2025. The entirety of the above-mentioned patent application is hereby incorporated by reference herein and made a part of this specification.

### BACKGROUND

### Technical Field

The present disclosure relates to the field of memory technology, and in particular to a memory control method and a storage device.

### Related Art

NAND flash memory is a form of non-volatile memory widely employed in electronic devices such as memory cards, solid-state drives (SSDs), and portable multimedia players. As an emerging storage medium, SSDs, which utilize NAND flash as the data storage medium, have been extensively adopted across personal computers, notebook computers, servers, and other fields, and are gradually supplanting mechanical hard disk drives (HDDs) to become the mainstream storage product.

As NAND flash cell fabrication has advanced to stacking architectures exceeding 300 layers, issues of threshold voltage distribution distortion in SSDs—arising from multi-bit storage technologies (QLC/PLC), device endurance degradation, and read/write crosstalk—have become increasingly pronounced, resulting in an exponential increase in raw bit error rate (RBER). The current mainstream solution adopts a Read Retry mechanism, which compensates for distribution shifts by dynamically adjusting the read reference voltage (Vref). Core implementation modes include: (1) an off-chip ECC-dependent mode, whereby a data page must be transferred via a DMA channel to an off-chip ECC engine for full decoding, and only upon a decoding failure is the reread process triggered. Experimental data indicate that this process reduces effective bandwidth utilization by 32%–47% (based on empirical measurements of Micron ZNS SSDs); (2) exhaustive voltage adjustment, which traverses multiple voltage points pursuant to a vendor-prescribed Vref search sequence, thereby introducing additional latency; and (3) a passive triggering mechanism, under which reread operations rely entirely on the ECC decoding outcome and cannot anticipate page quality prior to physical-layer data transfer. According to tests conducted under the JEDEC JESD219A standard, invalid transmissions of unrecoverable data pages consume 19.7%–34.6% of total channel bandwidth.

Accordingly, there is an urgent need to develop a reread optimization scheme endowed with the capability to pre-assess data quality, by implementing within the flash memory controller a real-time quality evaluation that is not dependent on decoding, thereby overcoming the systemic limitations of the related art with respect to bandwidth efficiency and response speed.

### SUMMARY

The present disclosure provides a memory control method and a storage device, which may improve the above problems, thereby enhancing the data reading efficiency of the storage device.

An embodiment of the present disclosure provides a memory control method for a storage device, wherein the storage device includes a memory module, and the memory control method includes: reading first data from a first physical unit in the memory module; after obtaining the first data from the memory module, on the premise of not performing a decoding operation on the first data through a decoding circuit, performing a data quality analysis on the first data to obtain a quality analysis result; if the quality analysis result is a first result, directly initiating a re-read operation for the first physical unit to re-read the first physical unit through a re-read voltage to obtain second data; and if the quality analysis result is a second result, performing the decoding operation on the first data through the decoding circuit.

An embodiment of the present disclosure further provides a storage device, which includes a connection interface, a memory module, and a memory controller. The connection interface is configured to connect to a host system. The memory controller is connected to the connection interface and the memory module. The memory controller is configured to: read first data from a first physical unit in the memory module; after obtaining the first data from the memory module, on the premise of not performing a decoding operation on the first data through a decoding circuit, perform a data quality analysis on the first data to obtain a quality analysis result; if the quality analysis result is a first result, directly initiate a re-read operation for the first physical unit to re-read the first physical unit through a re-read voltage to obtain second data; and if the quality analysis result is a second result, perform the decoding operation on the first data through the decoding circuit.

### BRIEF DESCRIPTION OF THE DRAWINGS

FIG. 1 is a schematic diagram of a data storage system according to an embodiment of the present disclosure;

FIG. 2 is a schematic diagram of a memory controller according to an embodiment of the present disclosure;

FIG. 3 is a schematic diagram of managing a memory module according to an embodiment of the present disclosure;

FIG. 4 is a schematic diagram of comparing target data with reference data according to an embodiment of the present disclosure;

FIG. 5 is a schematic diagram of parity check according to an embodiment of the present disclosure;

FIG. 6 is a schematic diagram of adjusting a re-read voltage according to an embodiment of the present disclosure;

FIG. 7 is a schematic diagram of a memory control circuit according to an embodiment of the present disclosure;

FIG. 8 is a flowchart of a memory control method according to an embodiment of the present disclosure.

### DESCRIPTION OF THE EMBODIMENTS

Reference will now be made in detail to the exemplary embodiments of the present disclosure, examples of which are illustrated in the accompanying drawings. Wherever possible, the same element symbols are used in the drawings and descriptions to refer to the same or similar parts.

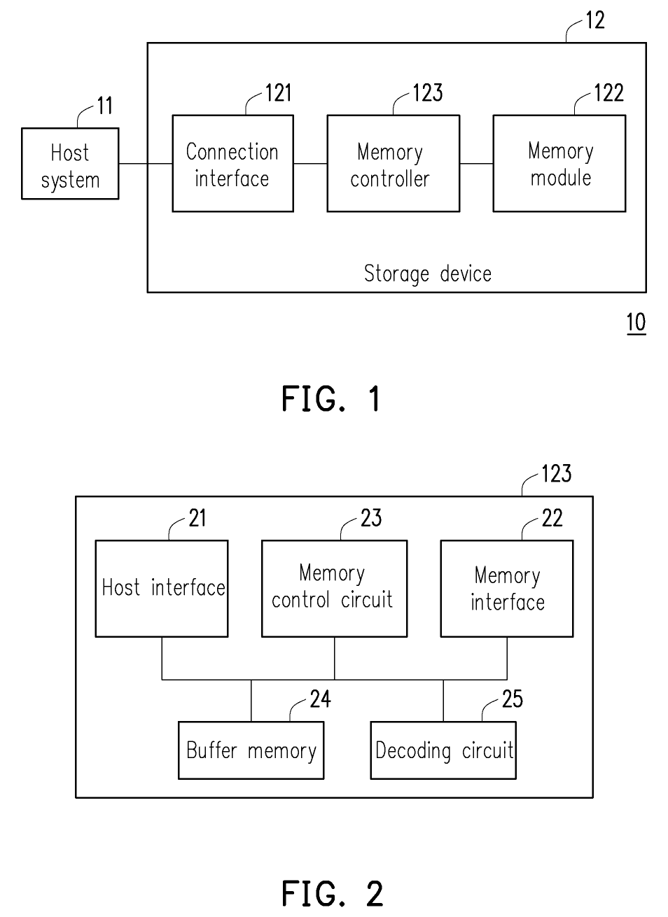

FIG. 1 is a schematic diagram of a data storage system according to an embodiment of the present disclosure. Please refer to FIG. 1, the data storage system 10 includes a host system 11 and a storage device 12. The storage device 12 may be connected to the host system 11 and may be configured to store data from the host system 11. For example, the host system 11 may be a smartphone, a tablet computer, a notebook computer, a desktop computer, an industrial computer, a game console, a server, or a computer system installed in a specific carrier (e.g., a vehicle, an aircraft, or a vessel), and the type of the host system 11 is not limited thereto. In addition, the storage device 12 may include a solid-state drive, a USB flash drive, a memory card, or other types of non-volatile storage devices.

The storage device 12 includes a connection interface 121, a memory module 122, and a memory controller 123. The connection interface 121 is configured to connect the storage device 12 to the host system 11. For example, the connection interface 121 may support embedded Multi-Media Card (eMMC), Universal Flash Storage (UFS), Peripheral Component Interconnect Express (PCI Express), Non-Volatile Memory Express (NVM express), Serial Advanced Technology Attachment (SATA), Universal Serial Bus (USB), or other types of connection interface standards. Therefore, the storage device 12 may communicate (e.g., exchange signals, instructions, and/or data) with the host system 11 via the connection interface 121.

The memory module 122 is configured to store data. For example, the memory module 122 may include one or more rewritable non-volatile memory modules. Each rewritable non-volatile memory module may include one or more memory cell arrays. The memory cells in the memory cell array store data in the form of voltages (also referred to as threshold voltages). For example, the memory module 122 may include a Single Level Cell (SLC) NAND flash memory module, a Multi Level Cell (MLC) NAND flash memory module, a Triple Level Cell (TLC) NAND flash memory module, a Quad Level Cell (QLC) NAND flash memory module, and/or other memory modules with the same or similar characteristics.

The memory controller 123 is connected to the connection interface 121 and the memory module 122. The memory controller 123 may be regarded as a control core of the storage device 12 and is configured to control the storage device 12. For example, the memory controller 123 may be configured to control or manage the overall or partial operations of the storage device 12. For example, the memory controller 123 may include a Central Processing Unit (CPU), or other programmable general-purpose or special-purpose microprocessors, a Digital Signal Processor (DSP), a programmable controller, Application Specific Integrated Circuits (ASIC), a Programmable Logic Device (PLD), or other similar devices or a combination of these devices. In an embodiment, the memory controller 123 may include a flash memory controller.

The memory controller 123 may send instruction sequences to the memory module 122 to access the memory module 122. For example, the memory controller 123 may send a write instruction sequence to the memory module 122 to instruct the memory module 122 to store data into specific memory cells. For example, the memory controller 123 may send a read instruction sequence to the memory module 122 to instruct the memory module 122 to read data from specific memory cells. For example, the memory controller 123 may send an erase instruction sequence to the memory module 122 to instruct the memory module 122 to erase data stored in specific memory cells. In addition, the memory controller 123 may further send other types of instruction sequences to the memory module 122 to instruct the memory module 122 to perform other types of operations, which is not limited in the present disclosure. The memory module 122 may receive the instruction sequence from the memory controller 123 and access the memory cells inside the memory module 122 according to the instruction sequence.

FIG. 2 is a schematic diagram of a memory controller according to an embodiment of the present disclosure. Please refer to FIGS. 1 and 2, the memory controller 123 includes a host interface 21, a memory interface 22, and a memory control circuit 23. The host interface 21 is configured to connect to the host system 11 via the connection interface 121 to communicate with the host system 11. The memory interface 22 is configured to connect to the memory module 122 to access the memory module 122.

The memory control circuit 23 is connected to the host interface 21 and the memory interface 22. The memory control circuit 23 may be configured to control or manage the overall or partial operations of the memory controller 123. For example, the memory control circuit 23 may communicate with the host system 11 via the host interface 21 and access the memory module 122 via the memory interface 22. For example, the memory control circuit 23 may include control circuits such as an embedded controller or a microcontroller. In the following embodiments, the description of the memory control circuit 23 is equivalent to the description of the memory controller 123.

In an embodiment, the memory controller 123 may further include a buffer memory 24. The buffer memory 24 is connected to the memory control circuit 23 and is configured to buffer data. For example, the buffer memory 24 may be configured to buffer instructions from the host system 11, data from the host system 11, and/or data from the memory module 122.

In an embodiment, the memory controller 123 may further include a decoding circuit 25. The decoding circuit 25 is connected to the memory control circuit 23 and is configured to perform encoding and decoding on data to ensure the correctness of the data. For example, the decoding circuit 25 may support Low Density Parity Check code (LDPC code), BCH code, Reed-solomon code (RS code), Exclusive OR (XOR) code, and other various encoding/decoding algorithms. In an embodiment, the memory controller 123 may further include other types of various circuit modules (e.g., power management circuits, etc.), which is not limited in the present disclosure.

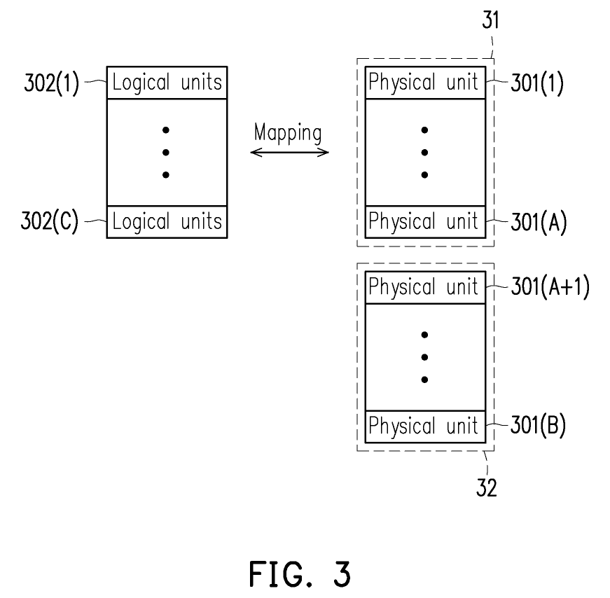

FIG. 3 is a schematic diagram of managing a memory module according to an embodiment of the present disclosure. Please refer to FIGS. 1 - 3, the memory module 122 includes a plurality of physical units 301(1)~301(B). Each physical unit includes a plurality of memory cells and is configured to store data non-volatilely.

In an embodiment, one physical unit may include one or more physical programming units. One physical erase unit may include a plurality of physical programming units.

In an embodiment, one physical programming unit may include a plurality of physical sectors. For example, the data capacity of one physical sector may be 512 bytes (B), and one physical programming unit may include 32 physical sectors. However, the data capacity of one physical sector and/or the total number of physical sectors included in one physical programming unit may be adjusted according to practical needs, which is not limited in the present disclosure. In an embodiment, one physical programming unit may be regarded as one physical page. For example, the storage capacity of one physical programming unit may be 16 kilobytes, and the present disclosure is not limited thereto.

In an embodiment, one physical programming unit is the minimum unit for synchronously writing data in the memory module 122. For example, when performing a programming operation (also referred to as a write operation) on one physical programming unit to write data into the physical programming unit, a plurality of memory cells in the physical programming unit may be synchronously programmed to store the corresponding data. For example, when programming one physical programming unit, a write voltage may be applied to the physical programming unit to change the threshold voltage of at least some of the memory cells in the physical programming unit. For example, the threshold voltage of one memory cell may reflect the bit data stored in the memory cell.

In an embodiment, a plurality of physical programming units in one physical erase unit may be synchronously erased. For example, when performing an erase operation on one physical erase unit, an erase voltage may be applied to the plurality of physical programming units in the physical erase unit to change the threshold voltage of at least some of the memory cells in the physical programming units. By performing an erase operation on one physical erase unit, the data stored in the physical erase unit may be erased. In an embodiment, one physical erase unit may be regarded as one physical block.

In an embodiment, the memory control circuit 23 may logically associate the physical units 301(1)~301(A) and 301(A+1)~301(B) with a data region 31 and a spare region 32, respectively. The physical units 301(1)~301(A) in the data region 31 all store data from the host system 11 (also referred to as user data). For example, any one of the physical units in the data region 31 may store valid data and/or invalid data. In addition, the physical units 301(A+1)~301(B) in the spare region 32 do not store any data (e.g., valid data).

In an embodiment, if a specific physical unit does not store valid data, the physical unit may be associated with the spare region 32. In addition, the physical units in the spare region 32 may be erased to remove the data in the physical units. In an embodiment, the physical units in the spare region 32 are also referred to as spare physical units. In an embodiment, the spare region 32 is also referred to as a free pool.

In an embodiment, when data is to be stored, the memory control circuit 23 may select one or more physical units from the spare region 32 and instruct the memory module 122 to store data into the selected physical units. After storing data into the physical units, the physical units may be associated with the data region 31. In other words, one or more physical units may be alternately used between the data region 31 and the spare region 32.

In an embodiment, the memory control circuit 23 may be provided with a plurality of logical units 302(1)~302(C) to map the physical units (i.e., physical units 301(1)~301(A)) in the data region 31. For example, one logical unit may correspond to one Logical Block Address (LBA) or other logical management units. One logical unit may be mapped to one or more physical units.

In an embodiment, if a specific physical unit is currently mapped by any logical unit, the memory control circuit 23 may determine that the data currently stored in the physical unit includes valid data. Conversely, if a specific physical unit is currently not mapped by any logical unit, the memory control circuit 23 may determine that the physical unit does not currently store any valid data.

In an embodiment, the memory control circuit 23 may record a mapping relationship between logical units and physical units in at least one management table (also referred to as a logical-to-physical mapping table). In an embodiment, the memory control circuit 23 may instruct the memory module 122 to perform data read, write, or erase operations according to the information in the management table (i.e., the logical-to-physical mapping table).

In an embodiment, the memory control circuit 23 may send a read instruction sequence to the memory module 122. The read instruction sequence is configured to instruct reading data (also referred to as first data) from a physical unit (also referred to as a first physical unit) in the memory module 122. For example, according to the read instruction sequence, the memory module 122 may read the first data from the first physical unit based on a read voltage (also referred to as a default read voltage) and transmit the first data to the memory control circuit 23. For example, the first physical unit may include at least one of the physical units 301(1)~301(A) in FIG. 3.

In an embodiment, after obtaining the first data from the memory module 122, on the premise that the decoding operation is not performed on the first data by the decoding circuit 25, the memory control circuit 23 may perform a data quality analysis on the first data to obtain a quality analysis result. For example, on the premise that the decoding operation is not performed on the first data by the decoding circuit 25, the quality analysis result may (roughly) reflect an error rate and/or reliability of the first data. Thereafter, the memory control circuit 23 may dynamically determine, according to the quality analysis result, whether to directly initiate a re-read operation for the first physical unit, or to perform a decoding operation on the first data by the decoding circuit 25. For example, the re-read operation is configured to re-read data from the first physical unit based on a re-read voltage different from the default read voltage. In addition, the decoding operation is configured to decode the first data to attempt to correct errors (e.g., error bits) in the first data.

In an embodiment, if the quality analysis result is a specific result (also referred to as a first result), the memory control circuit 23 may directly initiate a re-read operation for the first physical unit to re-read the first physical unit through the re-read voltage to obtain another data (also referred to as second data). For example, in the case where it is predicted based on the quality analysis result that the error rate of the first data is relatively high (e.g., higher than an error rate threshold) and/or the reliability is relatively low (e.g., lower than a reliability threshold) (i.e., the quality analysis result is the first result), the memory control circuit 23 may directly initiate a re-read operation for the first physical unit to re-send the read instruction sequence to re-read data from the first physical unit, in an attempt to obtain second data with a relatively low error rate (e.g., lower than the error rate threshold) and/or relatively high reliability (e.g., higher than the reliability threshold).

In an embodiment, directly initiating a re-read operation for the first physical unit in response to the first result may, in the case where the error rate of the first data is relatively high (e.g., higher than an error rate threshold), the reliability is relatively low (e.g., lower than a reliability threshold), and/or an evaluated current decoding success rate is relatively low (e.g., lower than a preset decoding success rate), skip the decoding operation for the first data and re-read the data. Thereby, the data read efficiency of the storage device may be improved.

In an embodiment, if the quality analysis result is another result (also referred to as a second result), the memory control circuit 23 may perform a decoding operation on the first data by the decoding circuit 25. For example, in the case where it is predicted based on the quality analysis result that the error rate of the first data is relatively low (e.g., lower than an error rate threshold) and/or the reliability is relatively high (e.g., higher than a reliability threshold) (i.e., the quality analysis result is the second result), the memory control circuit 23 may instruct the decoding circuit 25 to perform a decoding operation on the first data, in an attempt to obtain decoded data by decoding the first data. For example, compared to the original data (i.e., the original first data), the errors in the decoded data (i.e., the decoded first data) have been corrected.

In an embodiment, directly performing a decoding operation on the first data in response to the second result may, in the case where the error rate of the first data is relatively low (e.g., lower than an error rate threshold), the reliability is relatively high (e.g., higher than a reliability threshold), and/or the current decoding success rate is ensured to be relatively high (e.g., higher than a preset decoding success rate), decisively correct the errors in the first data quickly by performing the decoding operation. Thereby, the data read efficiency of the storage device may likewise be improved.

In other words, in an embodiment, after obtaining the first data from the memory module 122, the first data will not be directly input to the decoding circuit 25 for decoding (i.e., performing a decoding operation). On the contrary, after obtaining the first data from the memory module 122, before inputting the first data to the decoding circuit 25 (i.e., on the premise that the decoding operation is not performed on the first data by the decoding circuit 25), the memory control circuit 23 may first perform the data quality analysis on the first data to obtain the quality analysis result. In particular, the data quality analysis for the first data does not involve the operation of the decoding circuit 25. Then, based on the current situation (e.g., the quality analysis result), it is dynamically determined whether to directly initiate a re-read operation for the first physical unit, or to perform a decoding operation on the first data by the decoding circuit 25. Thereby, the data read efficiency of the storage device 12 may be significantly improved.

In an embodiment, after obtaining the first data from the memory module 122, the memory control circuit 23 may read reference data from the management table according to the logical unit (also referred to as a first logical unit) to which the first data belongs. For example, the first logical unit is mapped to the first physical unit. For example, the first logical unit may include at least one of the logical units 302(1)~302(C) in FIG. 3.

In an embodiment, the reference data includes feature data corresponding to the first data. The feature data is obtained by performing feature extraction on the first data during the period of storing the first data. For example, during the period of previously storing the data belonging to the first logical unit (i.e., the first data) into the memory module 122, the memory control circuit 23 may perform the feature extraction on the first data (i.e., extracting data features from the first data) to obtain the reference data corresponding to the first data. For example, the reference data (or feature data) may reflect the data features of at least partial data in the first data. After obtaining the reference data, the memory control circuit 23 may record the reference data in the management table by binding or matching the reference data with the first logical unit.

Thereafter, during the period of performing the data quality analysis on the first data, the memory control circuit 23 may obtain the reference data from the management table. For example, the memory control circuit 23 may query the management table based on the identification information (e.g., the number information or address information of the logical unit) of the first logical unit to read the reference data bound to or mutually matched with the first logical unit from the management table. Then, the memory control circuit 23 may perform the data quality analysis on the first data based on the reference data.

In an embodiment, after obtaining the reference data, the memory control circuit 23 may compare the first data with the reference data to obtain the quality analysis result. For example, without involving the processing of the first data by the decoding circuit 25, the memory control circuit 23 may compare the first data with the reference data to obtain an evaluation value (also referred to as a first evaluation value). For example, without involving the processing of the first data by the decoding circuit 25, the memory control circuit 23 may compare each bit in the first data with each bit in the reference data one by one to confirm whether the two are identical. Then, the memory control circuit 23 may obtain the first evaluation value according to the comparison result.

In an embodiment, the first evaluation value may reflect the degree of difference between the first data and the reference data. For example, the first evaluation value may be positively correlated with the degree of difference between the first data and the reference data. That is, the larger the first evaluation value, the greater the degree of difference between the first data and the reference data (i.e., the smaller the total number of bits that are identical between the first data and the reference data).

In an embodiment, the memory control circuit 23 may determine a relative numerical relationship between the first evaluation value and a threshold (also referred to as a first threshold) according to the first evaluation value. Then, the memory control circuit 23 may obtain the quality analysis result according to the relative numerical relationship. For example, according to different relative numerical relationships between the first evaluation value and the first threshold (e.g., the first evaluation value is greater than the first threshold, the first evaluation value is less than the first threshold, or the first evaluation value is equal to the first threshold), the memory control circuit 23 may obtain the corresponding quality analysis result.

In an embodiment, if the relative numerical relationship reflects that the first evaluation value is greater than the first threshold, the memory control circuit 23 may determine that the degree of difference between the first data and the reference data is relatively large (e.g., greater than a critical level). If the relative numerical relationship reflects that the first evaluation value is less than the first threshold, the memory control circuit 23 may determine that the degree of difference between the first data and the reference data is relatively small (e.g., less than the critical level). In addition, if the relative numerical relationship reflects that the first evaluation value is equal to the first threshold, the memory control circuit 23 may determine that the degree of difference between the first data and the reference data is neither large nor small (e.g., approaching the critical level). Thereafter, the memory control circuit 23 may determine the quality analysis result according to the relative numerical relationship (or the degree of difference between the first data and the reference data). In other words, the quality analysis result may reflect the degree of difference between the first data and the reference data.

In an embodiment, the degree of difference (or the first evaluation value) between the first data and the reference data may be positively correlated with the error rate of the first data and/or negatively correlated with the reliability of the first data. That is, if the degree of difference (or the first evaluation value) between the first data and the reference data is relatively large (e.g., the first evaluation value is greater than the first threshold), the memory control circuit 23 may determine that the error rate of the first data is relatively high (e.g., higher than an error rate threshold) and/or the reliability of the first data is relatively low (e.g., lower than a reliability threshold). On the contrary, if the degree of difference (or the first evaluation value) between the first data and the reference data is relatively small (e.g., the first evaluation value is less than the first threshold), the memory control circuit 23 may determine that the error rate of the first data is relatively low (e.g., lower than the error rate threshold) and/or the reliability of the first data is relatively high (e.g., higher than the reliability threshold).

In an embodiment, the memory control circuit 23 may determine a sampling window (also referred to as a dynamic sampling window) according to the first logical unit. For example, the management table may record the configuration information of the dynamic sampling window corresponding to or matching the first logical unit. Then, the memory control circuit 23 may query the management table according to the first logical unit to determine the dynamic sampling window. Then, the memory control circuit 23 may determine at least partial data (also referred to as target data) from the first data according to the dynamic sampling window.

In an embodiment, after determining the target data, the memory control circuit 23 may compare the target data with the reference data to obtain the quality analysis result. For example, the quality analysis result (or the first evaluation value) may reflect the degree of difference between the target data and the reference data.

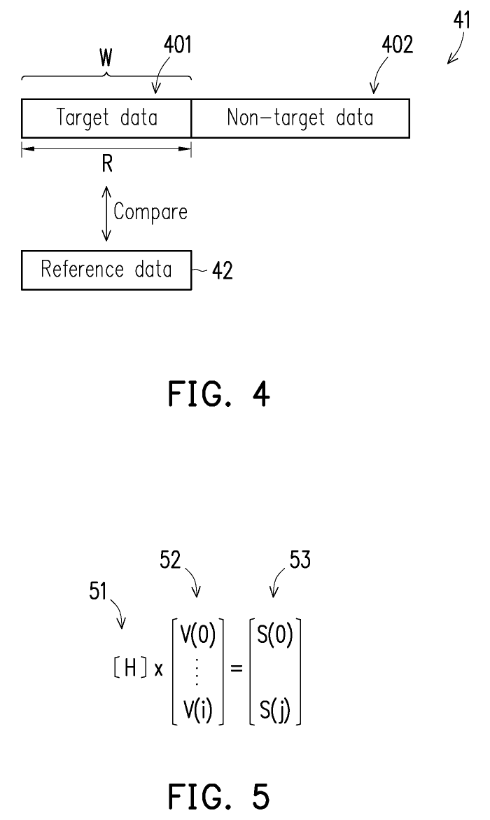

FIG. 4 is a schematic diagram illustrating a comparison between the target data and the reference data according to an embodiment of the present disclosure. Please refer to FIG. 4, in an embodiment, assume that the first data includes data 41. After reading the data 41 from the memory module 122, the memory control circuit 23 may query the management table to determine a sampling window W (i.e., a dynamic sampling window). For example, the sampling window W is configured to define a bit range R (also referred to as a target bit range) in the data 41.

In an embodiment, after determining the sampling window W, the memory control circuit 23 may determine or identify (all) data in the data 41 that is within the bit range R as the target data 401 according to the sampling window W. At the same time, the memory control circuit 23 may determine or identify (all) data in the data 41 that is not within the bit range R as non-target data 402 according to the sampling window W. Then, the memory control circuit 23 may compare the target data 401 within the bit range R in the data 41 with the reference data 42 to obtain a comparison result (or the first evaluation value). For example, the comparison result (or the first evaluation value) may reflect the degree of difference between the target data 401 and the reference data 42. Then, the memory control circuit 23 may obtain the quality analysis result according to the comparison result. In other words, in the embodiment of FIG. 4, the quality analysis result may reflect the degree of difference between the target data 401 and the reference data 42.

It should be noted that, in the embodiment of FIG. 4, the overall error rate and/or reliability of data 41 is evaluated based on the degree of difference between the target data 401 and the reference data 42. However, according to the type of data 41, the relative position of the sampling window W (or bit range R) in the data 41 and/or the total number of the sampling window W (or bit range R) may be adjusted according to practical requirements.

In an embodiment, after obtaining the first data from the memory module 122, the memory control circuit 23 may further perform a parity check on the first data to obtain another evaluation value (also referred to as a second evaluation value). The second evaluation value may reflect the error rate and/or reliability of the first data. For example, the second evaluation value may be positively correlated with the error rate of the first data and/or negatively correlated with the reliability of the first data. That is, the larger the second evaluation value, the higher the error rate of the first data and/or the lower the reliability of the first data. Then, the memory control circuit 23 may obtain the quality analysis result according to the second evaluation value. It should be noted that the parity check may be performed by the memory control circuit 23, but not by the decoding circuit 25.

FIG. 5 is a schematic diagram illustrating the parity check according to an embodiment of the present disclosure. Please refer to FIG. 5, in an embodiment, the memory control circuit 23 may obtain a matrix 51 (also referred to as a parity check matrix H), and assume that the first data includes a data vector 52. For example, the matrix 51 may be a (j+1)×(i+1) matrix, and i and j may be set according to requirements. Each element in the matrix 51 may be "1" or "0". In addition, the data vector 52 includes bits V(0)~V(j).

In an embodiment, in the parity check, the memory control circuit 23 may perform matrix multiplication on the matrix 51 and the data vector 52 to obtain a parity check vector 53. For example, the parity check vector 53 may reflect the result of performing matrix multiplication on the matrix 51 and the data vector 52. For example, the parity check vector 53 includes a plurality of elements S(0)~S(j). The elements S(0)~S(j) may also be referred to as syndromes, respectively. For example, each of the elements S(0)~S(j) may be "1" or "0".

In an embodiment, the memory control circuit 23 may obtain the quality analysis result according to the parity check vector 53. For example, the memory control circuit 23 may extract the elements S(0)~S(j) from the parity check vector 53 and obtain a sum of the elements S(0)~S(j). For example, the sum of the elements S(0)~S(j) may reflect (or be identical to) the total number of "1"s among the elements S(0)~S(j). In particular, the sum of the elements S(0)~S(j) may reflect the error rate and/or reliability of the first data. For example, the larger the sum of the elements S(0)~S(j), the higher the error rate of the first data and/or the lower the reliability of the first data.

In an embodiment, the memory control circuit 23 may obtain the quality analysis result according to the sum of the elements S(0)~S(j). In an embodiment, the memory control circuit 23 may obtain the second evaluation value according to the sum of the elements S(0)~S(j). For example, the second evaluation value may be identical to or positively correlated with the sum of the elements S(0)~S(j). Then, the memory control circuit 23 may obtain the quality analysis result according to the second evaluation value.

In an embodiment, the memory control circuit 23 may determine a relative numerical relationship between the second evaluation value and a threshold (also referred to as a second threshold) according to the second evaluation value. Then, the memory control circuit 23 may obtain the quality analysis result according to the relative numerical relationship. For example, according to different relative numerical relationships between the second evaluation value and the second threshold (e.g., the second evaluation value is greater than the second threshold, the second evaluation value is less than the second threshold, or the second evaluation value is equal to the second threshold), the memory control circuit 23 may obtain the corresponding quality analysis result.

In an embodiment, if the relative numerical relationship reflects that the second evaluation value is greater than the second threshold, the memory control circuit 23 may determine that the error rate of the first data is relatively high (e.g., higher than an error rate threshold) and/or the reliability of the first data is relatively low (e.g., lower than a reliability threshold). If the relative numerical relationship reflects that the second evaluation value is less than the second threshold, the memory control circuit 23 may determine that the error rate of the first data is relatively low (e.g., lower than the error rate threshold) and/or the reliability of the first data is relatively high (e.g., higher than the reliability threshold). Thereafter, without involving the decoding circuit 25 in processing the first data, the memory control circuit 23 may determine, according to the quality analysis result, whether to directly initiate a re-read operation for the first physical unit, or to perform a decoding operation on the first data through the decoding circuit 25. Thereby, the data read efficiency of the storage device 12 may be significantly improved.

In an embodiment, after obtaining the second data, the memory control circuit 23 may further compare the first data with the second data to obtain a comparison result. The comparison result may reflect the difference between the first data and the second data. Then, the memory control circuit 23 may adjust the re-read voltage used for the re-read operation according to the comparison result. Thereby, in the re-read operation performed by skipping the decoding of the first data, the errors in the read data may be further reduced, thus improving the data read efficiency of the storage device 12.

In an embodiment, if the comparison result reflects that the data difference between the first data and the second data decreases, it indicates that the first data and the second data are converging with each other. In this case, the memory control circuit 23 may maintain a current voltage adjustment direction for the re-read voltage. For example, assume that the current voltage adjustment direction for the re-read voltage is to gradually increase the voltage value of the re-read voltage. If the comparison result reflects that the data difference between the first data and the second data decreases, the memory control circuit 23 may not change the current voltage adjustment direction for the re-read voltage (i.e., gradually increasing the voltage value of the re-read voltage).

In an embodiment, if the comparison result reflects that the data difference between the first data and the second data increases, it indicates that the difference between the first data and the second data is expanding. In this case, the memory control circuit 23 may change the current voltage adjustment direction for the re-read voltage. For example, assume that the current voltage adjustment direction for the re-read voltage is to gradually increase the voltage value of the re-read voltage. If the comparison result reflects that the data difference between the first data and the second data increases, the memory control circuit 23 may switch to gradually decreasing the voltage value of the re-read voltage. Or, assume that the current voltage adjustment direction for the re-read voltage is to gradually decrease the voltage value of the re-read voltage. If the comparison result reflects that the data difference between the first data and the second data increases, the memory control circuit 23 may switch to gradually increasing the voltage value of the re-read voltage.

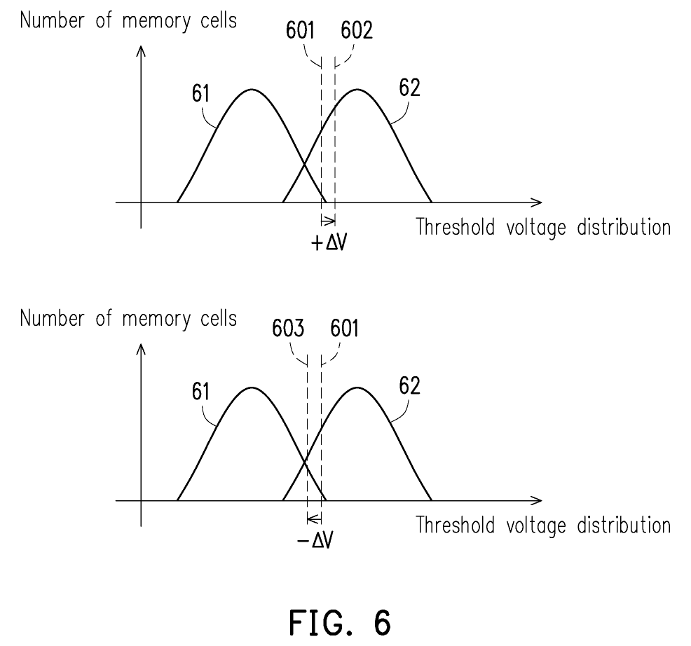

FIG. 6 is a schematic diagram illustrating the adjustment of the re-read voltage according to an embodiment of the present disclosure. Please refer to FIG. 6, assume that a threshold voltage distribution of a plurality of memory cells in the first physical unit includes a state 61 and a state 62. The state 61 and the state 62 correspond to different bits (or bit combinations).

In an embodiment, assume that the first data is read from the first physical unit based on a read voltage 601, and in the re-read operation for the first physical unit, the second data is read from the first physical unit based on a read voltage 602. After comparing the first data with the second data, if the comparison result reflects that the data difference between the first data and the second data gradually increases, it indicates that the current voltage adjustment direction of adding a voltage difference ΔV to the read voltage 601 to obtain the read voltage 602 is incorrect. In this case, the memory control circuit 23 may change the current voltage adjustment direction for the re-read voltage, for example, subtracting the voltage difference ΔV from the read voltage 601 to obtain a read voltage 603. In subsequent re-read operations for the first physical unit, the error rate of data read from the first physical unit based on the read voltage 603 has a higher probability of being lower than the error rate of data read from the first physical unit based on the read voltage 602 (and/or 601). Or, in subsequent re-read operations for the first physical unit, the reliability of data read from the first physical unit based on the read voltage 603 has a higher probability of being higher than the reliability of data read from the first physical unit based on the read voltage 602 (and/or 601). Thereby, in the re-read operation performed by skipping the decoding of the first data, the errors in the read data may be further reduced, thus improving the data read efficiency of the storage device 12.

In an embodiment, after obtaining the second data, without performing a decoding operation on the second data through the decoding circuit 25, the memory control circuit 23 may perform the data quality analysis on the second data to update the quality analysis result. It should be noted that the relevant operational details regarding how to perform the data quality analysis on specific data (e.g., the first data and/or the second data) to obtain or update the quality analysis result have been described in detail above, and will not be repeated here.

In an embodiment, after updating the quality analysis result, if the updated quality analysis result is the first result (e.g., in the case where the error rate of the second data is pre-estimated to be relatively high (e.g., higher than the error rate threshold) and/or the reliability is relatively low (e.g., lower than the reliability threshold)), and/or the current decoding success rate is estimated to be relatively low (e.g., lower than a preset decoding success rate), the memory control circuit 23 may initiate the re-read operation for the first physical unit again to attempt to directly re-read data with a lower error rate and/or higher reliability (also referred to as third data) based on a different re-read voltage before performing decoding on the second data through the decoding circuit 25. Thereby, the data read efficiency of the storage device 12 may be improved.

On the other hand, if the updated quality analysis result is the second result (e.g., in the case where the error rate of the second data is pre-estimated to be relatively low (e.g., lower than the error rate threshold) and/or the reliability is relatively high (e.g., higher than the reliability threshold)), the memory control circuit 23 may perform a decoding operation on the first data through the decoding circuit 25. Thereby, while ensuring that the current decoding success rate is relatively high (e.g., higher than the reliability threshold), the errors in the second data may be promptly corrected by decisively performing the decoding operation. Thereby, the data read efficiency of the storage device 12 may also be improved.

In an embodiment, the first data and second data may also respectively refer to any two pieces of data successively read from the first physical unit (or memory module 122) based on different re-read voltages in the re-read operation. The remaining operational details have been described in detail above, and will not be repeated here.

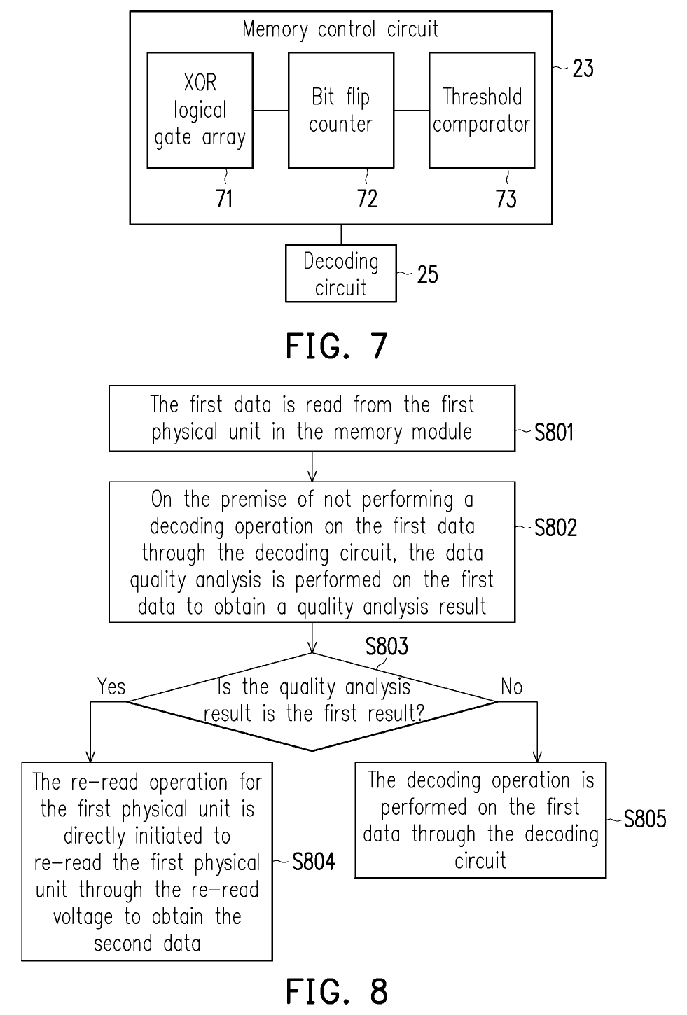

FIG. 7 is a schematic diagram illustrating the memory control circuit according to an embodiment of the present disclosure. Please refer to FIG. 7, in an embodiment, the memory control circuit 23 may include at least two of an XOR logical gate array 71, a bit flip counter 72, and a threshold comparator 73 to support the data quality analysis. For example, the XOR logical gate array 71 is configured to perform a bit-by-bit comparison between two pieces of data and output a comparison result. The bit flip counter 72 is configured to count the total number of different bits at the same positions between the two pieces of data. The threshold comparator 73 is configured to compare the total number with a threshold to obtain a comparison result.

In an embodiment, the XOR logical gate array 71, the bit flip counter 72, and/or the threshold comparator 73 may also provide corresponding computational behaviors based on their own performance. In an embodiment, the memory control circuit 23 may also include other types of circuit modules (e.g., matrix multiplication circuit modules, etc.). Thereby, the technical effect of performing the data quality analysis by the memory control circuit 23 itself without going through the decoding circuit 25 may be achieved.

FIG. 8 is a flowchart illustrating the memory control method according to an embodiment of the present disclosure. Please refer to FIG. 8, in step S801, the first data is read from the first physical unit in the memory module. After obtaining the first data from the memory module, in step S802, without performing a decoding operation on the first data through the decoding circuit, the data quality analysis is performed on the first data to obtain a quality analysis result. In step S803, it is determined whether the quality analysis result is the first result (or the second result). If the quality analysis result is the first result, in step S804, the re-read operation for the first physical unit is directly initiated to re-read the first physical unit through the re-read voltage to obtain the second data. However, if the quality analysis result is not the first result (i.e., is the second result), in step S805, the decoding operation is performed on the first data through the decoding circuit.

However, the steps in FIG. 8 have been described in detail above, and will not be repeated here. It is worth noting that the steps in FIG. 8 may be implemented as a plurality of program codes or circuits, and the present disclosure is not limited thereto. In addition, the method of FIG. 8 may be used in conjunction with the above exemplary embodiments, or may be used alone, and the present disclosure is not limited thereto.

In summary, the control method and the storage device proposed by the embodiments of the present disclosure may mitigate the technical problems of poor decoding efficiency and/or transmission bandwidth occupation between the decoding circuit and the memory control circuit caused by the conventional indiscriminate transmission of data read from the memory module to the decoding circuit for decoding, thereby improving the overall data read efficiency of the storage device.

Finally, it should be noted that: the above embodiments are only configured to illustrate the technical solutions of the present disclosure, rather than to limit the same; although the present disclosure has been described in detail with reference to the aforementioned embodiments, those of ordinary skill in the art should understand that: they may still modify the technical solutions described in the aforementioned embodiments, or make equivalent substitutions to some or all of the technical features therein; and such modifications or substitutions do not cause the essence of the corresponding technical solutions to depart from the scope of the technical solutions of the embodiments of the present disclosure.

What is claimed is:

1. A memory control method for a storage device, wherein the storage device comprises a memory module, and the memory control method comprises:
reading first data from a first physical unit in the memory module;
after obtaining the first data from the memory module, on the premise of not performing a decoding operation on the first data through a decoding circuit, performing a data quality analysis on the first data to obtain a quality analysis result;
if the quality analysis result is a first result, directly initiating a re-read operation for the first physical unit to re-read the first physical unit through a re-read voltage to obtain second data; and
if the quality analysis result is a second result, performing the decoding operation on the first data through the decoding circuit.

2. The memory control method according to claim 1, wherein the step of performing the data quality analysis on the first data to obtain the quality analysis result comprises:
reading reference data from a management table according to a first logical unit, wherein the first logical unit is mapped to the first physical unit, the reference data comprises feature data corresponding to the first data, and the feature data is obtained by performing feature extraction on the first data during a period of storing the first data; and
comparing the first data with the reference data to obtain the quality analysis result.

3. The memory control method according to claim 2, wherein the step of comparing the first data with the reference data to obtain the quality analysis result comprises:
comparing the first data with the reference data to obtain a first evaluation value, wherein the first evaluation value reflects a degree of difference between the first data and the reference data; and
obtaining the quality analysis result according to a numerical relative relationship between the first evaluation value and a threshold value.

4. The memory control method according to claim 2, wherein the step of comparing the first data with the reference data to obtain the quality analysis result comprises:
determining a dynamic sampling window according to the first logical unit;
determining target data from the first data according to the dynamic sampling window; and
comparing the target data with the reference data to obtain the quality analysis result.

5. The memory control method according to claim 1, wherein the step of performing the data quality analysis on the first data to obtain the quality analysis result comprises:
performing a parity check on the first data to obtain a second evaluation value, wherein the parity check is not performed by the decoding circuit; and
obtaining the quality analysis result according to the second evaluation value.

6. The memory control method according to claim 1, further comprising:
after obtaining the second data, comparing the first data with the second data to obtain a comparison result; and
adjusting the re-read voltage according to the comparison result.

7. The memory control method according to claim 6, wherein the step of adjusting the re-read voltage according to the comparison result comprises:
if the comparison result reflects that a data difference between the first data and the second data increases, changing a voltage adjustment direction of the re-read voltage.

8. The memory control method according to claim 1, further comprising:
after obtaining the second data, on the premise of not performing the decoding operation on the second data through the decoding circuit, performing the data quality analysis on the second data to update the quality analysis result;
if the updated quality analysis result is the first result, initiating the re-read operation for the first physical unit again; and
if the updated quality analysis result is the second result, performing the decoding operation on the second data by the decoding circuit.

9. The memory control method according to claim 1, wherein the step of performing the data quality analysis on the first data to obtain the quality analysis result is performed by a memory control circuit inside the storage device.

10. The memory control method according to claim 9, wherein the memory control circuit comprises at least two of an XOR logical gate array, a bit flip counter, and a threshold comparator to support the data quality analysis.

11. A storage device, comprising:
a connection interface configured to connect to a host system;
a memory module; and
a memory controller, connected to the connection interface and the memory module,
wherein the memory controller is configured to:
read first data from a first physical unit in the memory module;
after obtaining the first data from the memory module, on the premise of not performing a decoding operation on the first data through a decoding circuit, perform a data quality analysis on the first data to obtain a quality analysis result;
if the quality analysis result is a first result, directly initiate a re-read operation for the first physical unit to re-read the first physical unit through a re-read voltage to obtain second data; and
if the quality analysis result is a second result, perform the decoding operation on the first data through the decoding circuit.

12. The storage device according to claim 11, wherein the operation of the memory controller performing the data quality analysis on the first data to obtain the quality analysis result comprises:
reading reference data from a management table according to a first logical unit, wherein the first logical unit is mapped to the first physical unit, the reference data comprises feature data corresponding to the first data, and the feature data is obtained by performing feature extraction on the first data during a period of storing the first data; and
comparing the first data with the reference data to obtain the quality analysis result.

13. The storage device according to claim 12, wherein the operation of the memory controller comparing the first data with the reference data to obtain the quality analysis result comprises:
comparing the first data with the reference data to obtain a first evaluation value, wherein the first evaluation value reflects a degree of difference between the first data and the reference data; and
obtaining the quality analysis result according to a numerical relative relationship between the first evaluation value and a threshold value.

14. The storage device according to claim 12, wherein the operation of the memory controller comparing the first data with the reference data to obtain the quality analysis result comprises:
determining a dynamic sampling window according to the first logical unit;
determining target data from the first data according to the dynamic sampling window; and
comparing the target data with the reference data to obtain the quality analysis result.

15. The storage device according to claim 11, wherein the operation of the memory controller performing the data quality analysis on the first data to obtain the quality analysis result comprises:
performing a parity check on the first data to obtain a second evaluation value, wherein the parity check is not performed by the decoding circuit; and
obtaining the quality analysis result according to the second evaluation value.

16. The storage device according to claim 11, wherein the memory controller is further configured to:
after obtaining the second data, compare the first data with the second data to obtain a comparison result; and
adjust the re-read voltage according to the comparison result.

17. The storage device according to claim 16, wherein the operation of the memory controller adjusting the re-read voltage according to the comparison result comprises:
if the comparison result reflects that a data difference between the first data and the second data increases, changing a voltage adjustment direction of the re-read voltage.

18. The storage device according to claim 11, wherein the memory controller is further configured to:
after obtaining the second data, on the premise of not performing the decoding operation on the second data through the decoding circuit, perform the data quality analysis on the second data to update the quality analysis result;
if the updated quality analysis result is the first result, initiate the re-read operation for the first physical unit again; and
if the updated quality analysis result is the second result, perform the decoding operation on the second data by the decoding circuit.

19. The storage device according to claim 11, wherein the operation of the memory controller performing the data quality analysis on the first data to obtain the quality analysis result is performed by a memory control circuit inside the memory controller.

20. The storage device according to claim 19, wherein the memory control circuit comprises at least two of an XOR logical gate array, a bit flip counter, and a threshold comparator to support the data quality analysis.
